(19) United States
(12) Patent Application Publication
(10) Pub. No.: US 2017/0302319 A1
(43) Pub. Date: Oct. 19, 2017

(54) WEARABLE DEVICES AND METHODS FOR DATA TRANSMISSION AND RECEPTION THEREWITH

(71) Applicant: HUIZHOU TCL Mobile Communication Co., Ltd, Huizhou City, Guangdong (CN)

(72) Inventor: Yanfeng HUANG, Huizhou City (CN)

(73) Assignee: Huizhou TCL Mobile Communication Co., Ltd, Huizhou City, Guangdong (CN)

(21) Appl. No.: 15/322,053

(22) PCT Filed: Aug. 5, 2016
(86) PCT No.: PCT/CN2016/093639

§ 371 Date: Dec. 23, 2016

(30) Foreign Application Priority Data
Oct. 16, 2015 (CN) 201510676114.2

(51) Int. Cl. H04B 1/3827; H04W 76/02; H04L 29/06; H04W 84/12; H04W 4/00

(52) U.S. Cl. CPC H04B 1/385; H04W 76/02; H04L 69/161; H04W 4/008; H04W 84/12

(57) ABSTRACT

In a wearable device provided, the TCP/IP protocol and wireless communications protocol are separated from a primary MCU of the wearable device and are integrated into a secondary MCU integrated with a communication unit and coupled to an RF unit, the secondary MCU together with the communication unit and the RF unit acting as a communication module. The communication module is configured to perform data transmission with an external terminal or server using the wireless communications protocol and TCP/IP protocol. A method for data transmission or reception is also provided.

### CROSS-REFERENCE TO RELATED APPLICATIONS

The present application is a 35 U.S.C. §371 National Phase conversion of International (PCT) Patent Application No. PCT/CN2016/093639 filed Aug. 5, 2016, which claims foreign priority of Chinese Patent Application No. 201510676114.2, filed on Oct. 16, 2015 in the State Intellectual Property Office of China, the contents of all of which are hereby incorporated by reference.

### TECHNICAL FIELD

The field of the present disclosure relates to networking with wearable devices, and, more specifically, to wearable devices and methods for data transmission and reception therewith.

### BACKGROUND

As the market for wearable devices such as smart watches continues to grow, the wearable devices are no longer accessories of smart phones and are required to work independently. For example, when the wearer exercises outdoors, the wearable device is desired to independently timely upload the sports data to a cloud data center or receive weather data, stock data, etc., which requires the wearable device to have independent communication functionality. Presently, wearable devices typically use the Wi-Fi connection to achieve the desired communication functionality.

Current wearable devices available on the market are based on microcontroller unit (MCU) architecture, typically including a CPU, a random access memory (RAM), and a read-only memory (ROM) and equipped with a real-time operating system. Due to the resource constraints of the CPU and the memory, the RTOS cannot guarantee both the desired stability of the Wi-Fi connection and the system performance of the wearable device concurrently. If the associated Wi-Fi protocol is ported to the operating system of the wearable device, it may cause considerable workload for software transplant to the operating system, leading to software development risks.

### SUMMARY

In view of the above, embodiments of the present disclosure provide wearable devices and methods for data transmission and reception therewith, which can separate the TCP/IP protocol and the wireless communications protocol from the wearable device MCU to ensure the stability of the wireless network connection and the system performance of the wearable device concurrently.

There is provided a wearable device that comprises a first MCU, a second MCU coupled to the first MCU, and a radio-frequency (RF) antenna coupled to the second MCU. The second MCU may comprise a processor and a memory and may be integrated with a wireless network card that supports TCP/IP protocol and a wireless communication protocol, the memory storing program code. The processor may be configured to execute the program code to control the wireless network card to establish a wireless connection with an external terminal or server using the wireless communications protocol and to control the RF antenna to transmit and receive data communicated between the first MCU and the external terminal or server through the second MCU using the TCP/IP protocol.

The wearable device may further comprise a sensor coupled to the first MCU and configured to transfer its collected sensing data to the first MCU. The processor may be configured to execute the program code to control the RF antenna to receive the sensing data from the first MCU through the second MCU and then transmit the sensing data to the external terminal or server. The processor may also be configured to execute the program code to control the RF antenna to receive data sent from the external terminal or server and further transfer the data to the first MCU through the second MCU.

The sensor may be coupled to the first MCU through an interface of a first type, and the second MCU may be coupled to the first MCU through an interface of a second type.

The first-type interface may be an I2C interface which is a two-wire serial bus, and the second-type interface may be a universal asynchronous receiver/transmitter (UART) interface.

The wireless communications protocol may be a Wi-Fi protocol or a Bluetooth protocol.

There is also provided a wearable device that comprises a first MCU and a communication module, the communication module comprising a second MCU coupled to the first MCU and an RF unit coupled to the second MCU, the second MCU being integrated with a communication unit that supports TCP/IP protocol and a wireless communications protocol. When the wearable device transmits/receives data to/from an external terminal or server, the communication unit of the second MCU is configured to build up a wireless connection with the external terminal or server using the wireless communications protocol, and the RF unit is configured to transmit/receive data communicated between the first MCU and the external terminal or server through the second MCU using the TCP/IP protocol.

The wearable device may further comprise a sensing module coupled to the first MCU and configured to transfer its collected sensing data to the first MCU which further transfers the sensing data to the second MCU, which may further transmit the sensing data to the external terminal or server by the RF unit; or the RF unit may be configured to receive data from the external terminal or server and further transfer the data to the first MCU through the second MCU.

The sensing module may be coupled to the first MCU through an interface of a first type, and the second MCU may be coupled to the first MCU through an interface of a second type.

The first-type interface may be an I2C interface which is a two-wire serial bus, and the second-type interface may be a UART interface.

The wireless communications protocol may be a Wi-Fi protocol or Bluetooth protocol.

There is also provided a method for data transmission and reception with a wearable device that comprises a first MCU and a communication module having an RF unit, the method comprising: installing a second MCU in the communication module, the second MCU being coupled to the first MCU and the RF unit respectively and integrated with a communication unit that supports TCP/IP protocol and a wireless communications protocol; establishing, by the communication unit of the second MCU, a wireless connection with an external terminal or server using the wireless communications protocol; and transmitting/receiving, by the RF unit, data communicated between the first MCU and the external terminal or server through the second MCU using the TCP/IP protocol.

The wearable device may further comprise a sensing module coupled to the first MCU, where the RF unit transmitting/receiving data communicated between the first MCU and the external terminal or server using the TCP/IP protocol may comprise: transferring, by the sensing module, its collected sensing data to the first MCU and further to the second MCU through the first MCU, and receiving, by the RF unit, the sensing data from the second MCU and further transmitting the sensing data to the external terminal or server; or receiving, by the RF unit, data from the external terminal or server and further transferring the data to the first MCU through the second MCU.

The sensing module may be coupled to the first MCU through an interface of a first type, and the second MCU may be coupled to the first MCU through an interface of a second type.

The first-type interface may be an I2C interface which is a two-wire serial bus, and the second-type interface may be a UART interface.

The wireless communications protocol may be a Wi-Fi protocol or Bluetooth protocol.

In the wearable devices and associated method for data transmission and reception that are provided by embodiments of the disclosure, the TCP/IP protocol and the wireless communications protocol are embedded in a separate MCU instead of being transplanted to the wearable device MCU. That is, the TCP/IP protocol and the wireless communications protocol are independent from the operating system of the wearable device, so that the operating system can be simplified while the desired wireless network connection stability and the wearable device system performance can be ensured concurrently, also the workload for the operating system development is reduced, which are conducive to locating the system failures and analyzing the relevant causes, improving the software development efficiency while reducing potential software development risks.

### BRIEF DESCRIPTION OF THE DRAWINGS

FIG. 1 depicts an embodiment of a wearable device according to the disclosure.

FIG. 2 depicts an embodiment of a method for data transmission or reception with a wearable device according to the disclosure.

FIG. 3 depicts another embodiment of a wearable device according to the disclosure.

### DETAILED DESCRIPTION

Hereinafter, implementations of the present disclosure will be described in definite and comprehensive details in connection with exemplary embodiments with reference to the accompanying drawings.

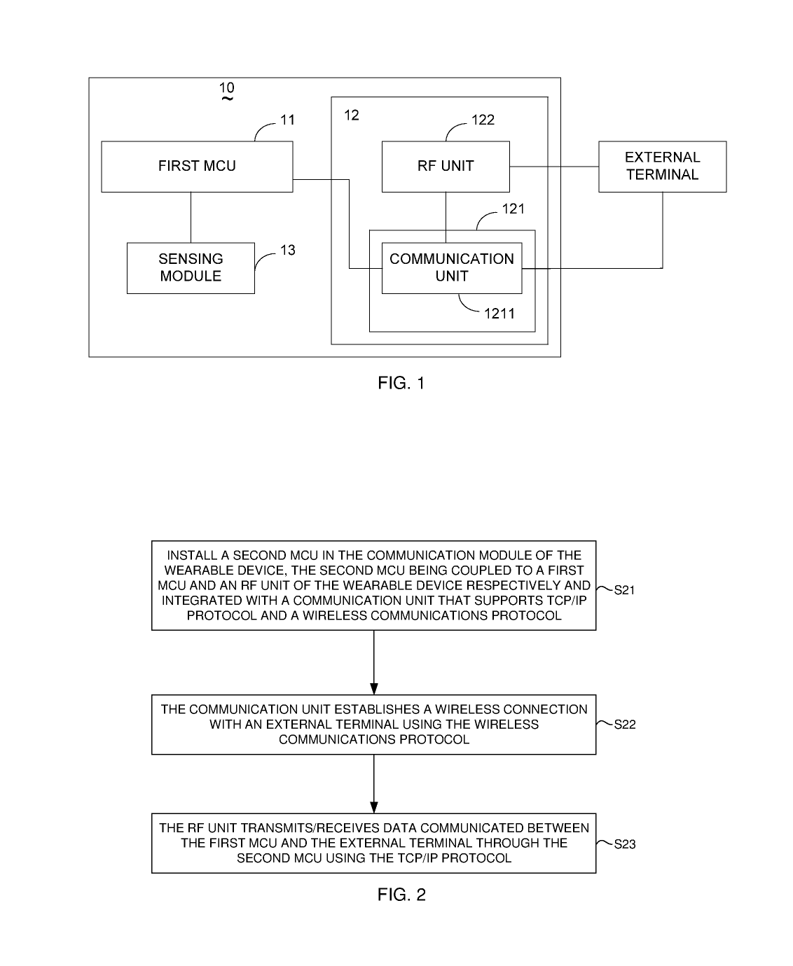

FIG. 1 depicts an embodiment of a wearable device according to the disclosure. As observed in FIG. 1, the wearable device 10 comprises a first MCU 11 and a communication module 12. When the wearable device 10 needs to transmit/receive data to/from an external terminal or server, the communication module 12 may establish a wireless connection with the external terminal or server using a wireless communications protocol, and upon establishment of the wireless connection, transmit/receive data communicated between the first MCU 11 and the external terminal or server using a data transfer protocol (e.g., transmission control protocol/Internet protocol, abbreviated to TCP/IP protocol, also known as network communications protocol). By the data transmission or reception, it means that communication module 12 transmits data to be sent by the first MCU 11 to the external terminal or server, or the communication module 12 receives data from the external terminal or server and transfers the data to the first MCU 11. The external terminal may be a portable communicating device such as a mobile phone, a computer, etc.

Differing from the prior art, in the present embodiment the communication module 12 also comprises a micro-control unit, i.e., a second MCU 121, into which is integrated a communication unit 1211 that supports the aforementioned wireless communications protocol and data transfer protocol. The communication module 12 further comprises a RF unit 122. When the wearable device 10 needs to transmit/receive data to/from the external terminal or server, the first MCU 11 is coupled to the second MCU 121, the communication unit 1211 of the second MCU 121 may establish a wireless connection with the external terminal or server using the wireless communications protocol, and the RF unit 122 may transmit/receive data communicated between the first MCU 11 and the external terminal or server through the second MCU 121 using the data transfer protocol.

That is, the data transfer protocol and the wireless communications protocol are separated from the MCU (operating system) of the wearable device 10 so that the wireless connection stability as well as the operating system performance of the wearable device 10 can be ensured concurrently. Thus, the operating system of the wearable device 10 can be simplified and the workload for the operating system development can be reduced. Further, simplification of the operating system is conducive to locating wireless connection failures, data transmission failures, or operating system failures, improving the software development efficiency while reducing potential software development risks.

In the present embodiment, the data transmitted by or received at the communication module 12 can be the data collected by a sensing module 13 built in or external to the wearable device 10. The sensing module 13 may be, e.g., a microphone, camera, acceleration detection equipment, or temperature sensor. The sensing module 13 may be coupled to the first MCU 11, and so may transfer its collected sensing data to the first MCU 11. The first MCU 11 may then convey the sensing data to the second MCU 121, which may further transfer the sensing data to the RF unit 122, and the RF unit 122 may finally transmit the sensing data to the external terminal or server.

The wearable device 10 may also receive other types of data from the external terminal or server, of course. Specifically, the second MCU 121 may receive external data from the external terminal or server and transfer the external data to the first MCU 11.

Typically, the sensing module 13 may be coupled to the first MCU 11 through an interface of a first type, while the second MCU 121 may be coupled to the first MCU 11 through an interface of a second type. The first-type interface can be an I2C (Inter-Integrated Circuit) interface, while the second-type interface can be a UART (universal asynchronous receiver/transmitter) interface or the I2C interface. That is, the same type of interface or different types of interfaces may be used between the sensing device 13 and the first MCU 11 and between the second MCU 121 and the first MCU 11.

Further, in the present embodiment the wireless communications protocol may be Wi-Fi protocol or a Bluetooth protocol. In the Wi-Fi protocol, for example, the Wi-Fi software architecture for software development can be a multi-layer architecture that contains the MAC (media access control) address and the baseband and radio information in the RF chip of the communication module 12. In addition, for the data transfer protocol (e.g., TCP/IP protocol) on the higher layers, the WIFI Driver information, Supplicant information, TLS/SSL (transport layer security/secure sockets layer) information, Protocols information, and Application information run in the second MCU 121 of the communication module 12. These software programs have strict requirements on the operating frequency of the MCU, the response time of the OS, and the RAM size. Therefore, if these software programs are ported to the operating system of the wearable device 10 and tailored compatible with the operating system, a large amount of software migration efforts would be required and, subject to hardware factors, the connection stability and the performance of the operating system of the wearable device 10 may be largely affected even if the wireless connection is possible. While in the present embodiment the Wi-Fi protocol software is installed in a separate MCU (i.e., the second MCU 121) in the communication module 12, and is associated with the operating system of the wearable device 10 only when data transmission and reception is performed, thus avoiding the potential risks and difficulties in the otherwise required software development.

FIG. 2 depicts an embodiment of a method for data transmission or reception with a wearable device according to the disclosure. As observed in FIG. 2, the method may comprise the following blocks.

In S21, a second MCU is installed in a communication module of the wearable device, the second MCU being integrated with a communication unit that supports a data transfer protocol and a wireless communications protocol and being independent from a first MCU running an operating system of the wearable device.

In S22, when the wearable device sends/receives data to/from the external terminal or server, the first MCU is coupled to the second MCU, the communication unit of the second MCU may establish a wireless connection with the external terminal or server using the wireless communications protocol, and the RF unit may transmit/receive data communicated between the first MCU and the external terminal or server through the second MCU using the data transfer protocol.

Blocks of the method according to the present embodiment can be performed by the wearable device 10 described in the previous embodiment, and thus may achieve equivalent technical effects to the previous embodiment.

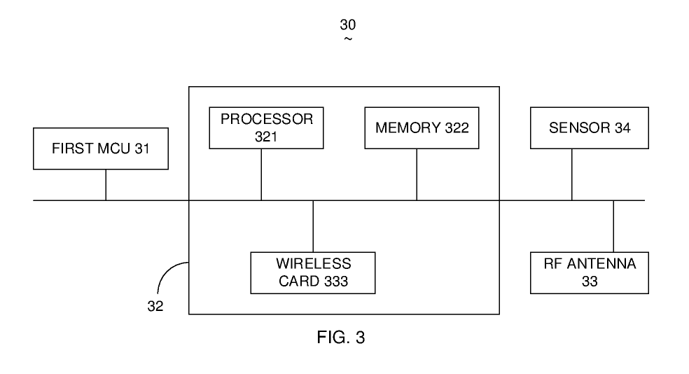

FIG. 3 depicts another embodiment of a wearable device according to the disclosure. As observed in FIG. 3, the wearable device 30 comprises a first MCU 31, a second MCU 32, and an RF antenna 33. The second MCU 32 may comprise a processor 321 and a memory 322 and may be integrated with a wireless network card 333 that supports TCP/IP protocol and a wireless communications protocol. The memory 322 may store program code that is configured to enable the data transmission and reception between the wearable device 30 and an external terminal or server. The processor 321, memory 322, wireless network card 333, and RF antenna 33 are coupled with each other.

The processor 321 may be configured to:

execute the program code to control the wireless network card 333 to establish a wireless connection with the external terminal or server using the wireless communications protocol, and control the RF antenna 33 to transmit/receive data communicated between the first MCU 31 and the external terminal or server through the second MCU using the TCP/IP protocol. The wireless communications protocol may be, but not limited to, a Wi-Fi protocol or a Bluetooth protocol.

Optionally, the wearable device 30 may further comprise a sensor 34 coupled to the first MCU 31 and configured to transfer its collected data to the first MCU 31. The processor 321 may be configured to execute the program code to control the RF antenna 33 to receive the sensing data from the first MCU 31 through the second MCU and then transmit the sensing data to the external terminal or server. The processor 321 may also be configured to control the RF antenna 33 to receive the data sent from the external terminal or server and further transfer the data to the first MCU 31 through the second MCU 32.

Optionally, the sensor 34 may be coupled to the first MCU 31 through an interface of a first type, and the second MCU 32 may be coupled to the first MCU 31 through an interface of a second type. The first-type interface may be, but not limited to, an I2C interface, while the second-type interface may be, but not limited to, a UART interface.

The foregoing specification merely depicts some exemplary embodiments of the present disclosure rather than limits the scope of the disclosure. It will be evident that various structural or flow modifications may be made to the disclosure or the disclosure may be directly or indirectly applied on any other related fields, where all these modifications or applications shall fall in the scope of the disclosure.

1. A wearable device, comprising:
a first MCU;
a second MCU, coupled to the first MCU and comprising a processor and a memory and being integrated with a wireless network card that supports TCP/IP protocol and a wireless communications protocol, the memory storing program code; and
an RF antenna coupled to the second MCU;
wherein the processor is configured to: execute the program code to control the wireless network card to establish a wireless connection with an external terminal or a server using the wireless communications protocol; and execute the program code to control the RF antenna to transmit and receive data communicated between the first MCU and the external terminal or server through the second MCU using the TCP/IP protocol.

2. The wearable device according to claim 1, further comprising a sensor coupled to the first MCU and configured to transfer its collected sensing data to the first MCU, wherein the processor is configured to: execute the program code to control the RF antenna to receive the sensing data from the first MCU through the second MCU and further transmit the sensing data to the external terminal or server; and execute the program code to control the RF antenna to receive data from the first external terminal or server, and further transfer the data to the first MCU through the second MCU.

3. The wearable device according to claim 2, wherein the sensor is coupled to the first MCU through an interface of a first type, and the second MCU is coupled to the first MCU through an interface of a second type.

4. The wearable device according to claim 3, wherein the first-type interface is an I2C interface and the second-type interface is a UART interface.

5. The wearable device according to claim 1, wherein the wireless communications protocol is a Wi-Fi protocol or Bluetooth protocol.

6. A wearable device, comprising:
a first MCU; and
a communication module, comprising a second MCU coupled to the first MCU and an RF unit coupled to the second MCU, the second MCU being integrated with a communication unit that supports TCP/IP protocol and a wireless communications protocol;
wherein the communication unit of the second MCU is configured to establish a wireless connection with an external terminal or server using the wireless communications protocol, and the RF unit is configured to transmit and receive data communicated between the first MCU and the external terminal or server through the second MCU using the TCP/IP protocol.

7. The wearable device according to claim 6, further comprising a sensing module coupled to the first MCU and configured to transfer its collected sensing data to the first MCU which further transfers the sensing data to the second MCU, and the second MCU further transmits the sensing data to the external terminal or server by the RF unit; the RF unit is configured to receive data from the external terminal or server and further transfer the data to the first MCU through the second MCU.

8. The wearable device according to claim 7, wherein the sensing module is coupled to the first MCU through an interface of a first type, and the second MCU is coupled to the first MCU through an interface of a second type.

9. The wearable device according to claim 8, wherein the first-type interface is an I2C interface and the second-type interface is a UART interface.

10. The wearable device according to claim 6, wherein the wireless communications protocol is a Wi-Fi protocol or Bluetooth protocol.

11. A method for data transmission or reception with a wearable device, the wearable device comprising a first MCU and a communication module having an RF unit, the method comprising:
installing a second MCU in the communication module, the second MCU being coupled to the first MCU and the RF unit respectively and integrated with a communication unit that supports TCP/IP protocol and a wireless communications protocol;
establishing, by the communication unit of the second MCU, a wireless connection with an external terminal or server using the wireless communications protocol; and
transmitting and receiving, by the RF unit data communicated between the first MCU and the external terminal or server through the second MCU using the TCP/IP protocol.

12. The method according to claim 11, wherein the wearable device further comprises a sensing module coupled to the first MCU, where the RF unit transmitting and receiving the data communicated between the first MCU and the external terminal or server comprises:
transferring, by the sensing module, its collected sensing data to the first MCU which further transfers the sensing data to the second MCU; and receiving, by the RF unit, the sensing data from the second MCU and further transmitting the sensing data to the external terminal or server; and
receiving, by the RF unit, data from the external terminal or server and further transferring the data to the first MCU through the second MCU.

13. The method according to claim 12, wherein the sensing module is coupled to the first MCU through an interface of a first type, and the second MCU is coupled to the first MCU through an interface of a second type.

14. The method according to claim 13, wherein the first-type interface is an I2C interface and the second-type interface is a UART interface.

15. The method according to claim 11, wherein the wireless communications protocol is a Wi-Fi protocol or Bluetooth protocol.

16. The wearable device according to claim 1, wherein the external terminal is a mobile phone or a computer.

17. The wearable device according to claim 3, where types of the interfaces between the sensor and the first MCU and between the second MCU and the first MCU are the same.

18. The wearable device according to claim 6, wherein the external terminal is a mobile phone or a computer.

19. The wearable device according to claim 8, wherein types of the interfaces between the sensing module and the first MCU and between the second MCU and the first MCU are the same.

20. The method according to claim 11, wherein the external terminal is a mobile phone or a computer.
